(19) United States
(12) Patent Application Publication
(10) Pub. No.: US 2016/0275645 A1
(43) Pub. Date: Sep. 22, 2016

(54) SELECTION SUPPORT APPARATUS, SELECTION SUPPORT METHOD, AND NON-TRANSITORY COMPUTER READABLE MEDIUM

(71) Applicant: Fuji Xerox Co., Ltd., Tokyo (JP)

(72) Inventors: Kosuke MARUYAMA, Ashigarakami-gun (JP); Makoto SASAKI, Ashigarakami-gun (JP)

(21) Appl. No.: 14/831,049

(22) Filed: Aug. 20, 2015

(30) Foreign Application Priority Data
Mar. 19, 2015 (JP) 2015-056904

(51) Int. Cl. G06T 3/40; G06F 3/0488; G06F 3/0484

(52) U.S. Cl. CPC G06T 3/40; G06F 3/04842; G06F 3/04883

(57) ABSTRACT

A selection support apparatus includes a display, an enlarging unit, and a determining unit. The display displays an image on a display screen including multiple unit regions in which a designation operation by an operator is detected. The enlarging unit enlarges the image such that a part of the image displayed on one of the multiple unit regions of the display screen is displayed on an enlarged region including two or more of the plural unit regions neighboring each other of the display screen. The determining unit determines that the part of the image is selected if the designation operation by the operator is detected in all or at least one of the unit regions included in the enlarged region.

### CROSS-REFERENCE TO RELATED APPLICATIONS

This application is based on and claims priority under 35 USC 119 from Japanese Patent Application No. 2015-056904 filed Mar. 19, 2015.

### BACKGROUND

### Technical Field

The present invention relates to a selection support apparatus, a selection support method, and a non-transitory computer readable medium.

### SUMMARY

According to an aspect of the invention, there is provided a selection support apparatus including a display, an enlarging unit, and a determining unit. The display displays an image on a display screen including multiple unit regions in which a designation operation by an operator is detected. The enlarging unit enlarges the image such that a part of the image displayed on one of the multiple unit regions of the display screen is displayed on an enlarged region including two or more of the multiple unit regions neighboring each other of the display screen. The determining unit determines that the part of the image is selected if the designation operation by the operator is detected in all or at least one of the unit regions included in the enlarged region.

### BRIEF DESCRIPTION OF THE DRAWINGS

An exemplary embodiment of the present invention will be described in detail based on the following figures, wherein:

FIG. 1 is a diagram illustrating a configuration example of an image processing system in the exemplary embodiment of the present invention;

FIG. 2 is a block diagram illustrating a functional configuration example of an image processing apparatus in the exemplary embodiment of the present invention;

FIGS. 3A, 3B, and 3C are each a diagram for explaining how an enlargement processor performs processing;

FIGS. 4A and 4B are each a diagram illustrating an example of how enlarged pixels are displayed when the enlargement processor enlarges an image;

FIGS. 5A, 5B, and 5C are each a diagram for explaining how a seed setting unit performs processing when one or more dots are selected on the basis of a point;

FIGS. 6A, 6B, and 6C are each a diagram for explaining how the seed setting unit performs processing when dots are selected on the basis of a line;

FIG. 7 is a diagram for explaining how the seed setting unit performs processing by using the feature amount of pixels;

FIG. 8 is a flowchart illustrating an example of operation of the image processing apparatus in the exemplary embodiment of the present invention; and

FIG. 9 is a diagram illustrating a hardware configuration example of a computer to which the exemplary embodiment of the present invention is applicable.

### DETAILED DESCRIPTION

Hereinafter, an exemplary embodiment of the present invention will be described in detail with reference to the attached drawings.

### Image Processing System

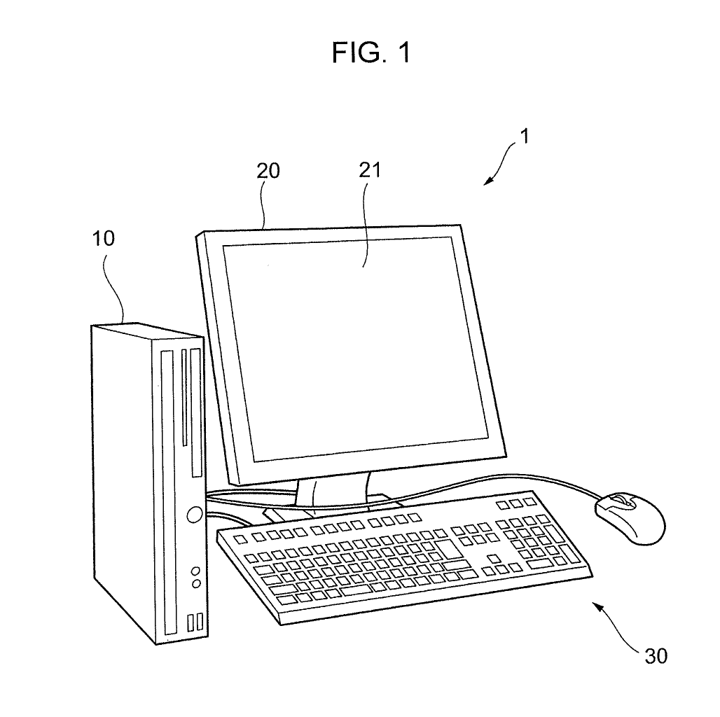

FIG. 1 is a diagram illustrating a configuration example of an image processing system 1 in the exemplary embodiment of the present invention. As illustrated in FIG. 1, the image processing system 1 in the present exemplary embodiment includes an image processing apparatus 10, a display 20, and an input device 30. The image processing apparatus 10 performs image processing on image information regarding an image displayed on the display 20. The display 20 receives the image information generated by the image processing apparatus 10 and displays the image on the basis of the image information. The input device 30 is provided in order that a user inputs various information pieces in the image processing apparatus 10.

The image processing apparatus 10 is an example of a selection support apparatus and, for example, a so-called “general-purpose personal computer (PC)”. The image processing apparatus 10 is designed to perform image information generation or the like by running various software applications under the control of an operating system (OS).

The display 20 displays the image on a display screen 21. The display 20 includes a device such as a liquid crystal display for PC, a liquid crystal display television set, or a projector, the device having a function of displaying an image on the basis of an additive color mixture. Accordingly, a display system used by the display 20 is not limited to the liquid crystal system. In the example in FIG. 1, the display screen 21 is incorporated into the display 20. However, in a case where, for example, a projector is used as the display 20, a screen or the like is provided as the display screen 21 outside the display 20.

The input device 30 includes a keyboard, a mouse, and the like. The input device 30 is used for starting and terminating image processing application software and inputting designation for image processing into the image processing apparatus 10 (described later in detail).

The image processing apparatus 10 is connected to the display 20 on the basis of, for example, digital visual interface (DVI). Instead of DVI, high-definition multimedia interface (HDMI) (registered trademark), DisplayPort, or the like may be used for the connection.

The image processing apparatus 10 is also connected to the input device 30 on the basis of, for example, universal serial bus (USB). Instead of USB, IEEE1394, RS-232C, or the like may be used for the connection.

In the image processing system 1 as described above, the display 20 first displays an original image that is an image yet to undergo image processing. When the user inputs designation for the image processing into the image processing apparatus 10 by using the input device 30, the image processing apparatus 10 performs the image processing on the image information regarding the original image. The result of the image processing is reflected on the image displayed on the display 20, and the display 20 displays the image that has undergone the image processing and has thus been redrawn.

The mode of the image processing system 1 in the present exemplary embodiment is not limited to the mode in FIG. 1. For example, a tablet terminal may be used as the image processing system 1. In this case, the tablet terminal includes a touch panel, and the touch panel is used for not only displaying an image but also detecting user designation. In other words, the touch panel functions as the display 20 and the input device 30. A touch monitor may also be used, the touch monitor being a device into which the display 20 and the input device 30 are integrated. The touch monitor has a touch panel serving as the display screen 21 of the aforementioned display 20. In this case, the image processing apparatus 10 generates image information, and the touch monitor displays an image on the basis of the image information. The user inputs designation for image processing by touching or the like on the touch monitor.

As described above, the display screen 21 has minimum-unit regions in which designation input from the input device 30 is detected, regardless of whether the display 20 is a device different from the input device 30, functions as the input device 30, or is integrated with the input device 30. In the present exemplary embodiment, the minimum-unit regions are used as an example of unit regions in which a designation operation by a user is detected. In addition, the display screen 21 is provided as an example of a display screen having multiple unit regions, and the display 20 is provided as an example of a display that displays an image on the display screen.

### Configuration of Image Processing Apparatus

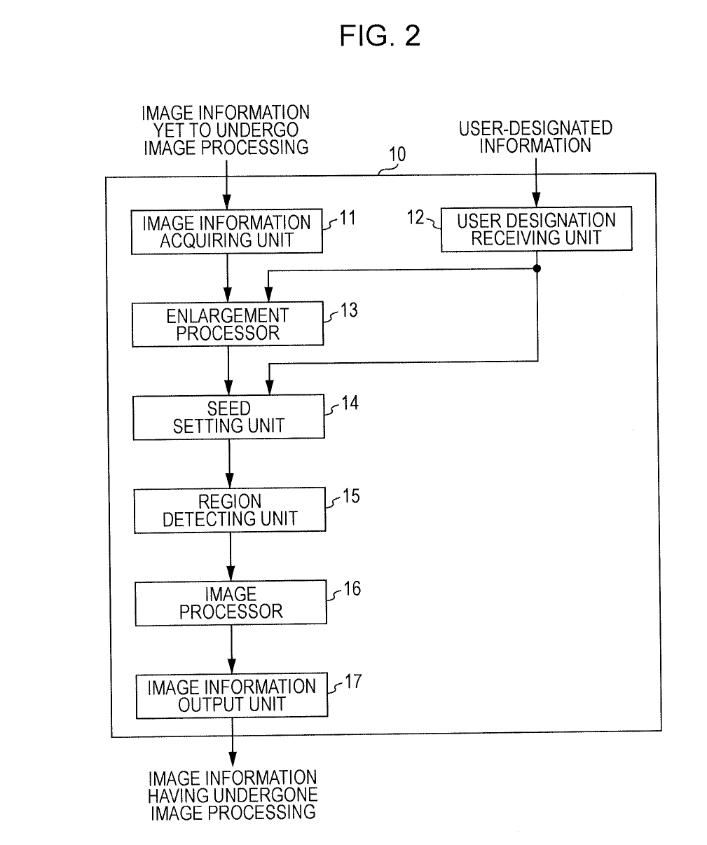

FIG. 2 is a block diagram illustrating a functional configuration example of the image processing apparatus 10 in the exemplary embodiment of the present invention. Note that FIG. 2 illustrates functions related to the present exemplary embodiment that are selected from various functions of the image processing apparatus 10. As illustrated in FIG. 2, the image processing apparatus 10 in the present exemplary embodiment includes an image information acquiring unit 11, a user designation receiving unit 12, an enlargement processor 13, a seed setting unit 14, a region detecting unit 15, an image processor 16, and an image information output unit 17.

The image information acquiring unit 11 acquires the image information regarding the original image. Specifically, the image information acquiring unit 11 acquires image information yet to undergo image processing. The image information is, for example, red, green, and blue (RGB) video data for displaying an image on the display 20.

The user designation receiving unit 12 receives image processing designation input by the user through the input device 30. Specifically, the user designation receiving unit 12 receives, as user-designated information, designation for obtaining an enlarged image by enlarging the original image displayed on the display 20. The user designation receiving unit 12 also receives, as user-designated information, designation for selecting one or more dots on the enlarged image. The user designation receiving unit 12 receives the designation so as to set a seed on the original image by using the enlarged image displayed on the display 20. The term “seed” denotes a movement line, a point, or the like resulting from an operation performed by the user on a specific region for segregating the region from the other regions. The movement line, the point, or the like may be set, for example, by dragging the mouse on the image displayed on the display screen or by moving a finger of the user, a touch pen, or the like over the image displayed on the display screen.

The enlargement processor 13 performs image processing on the image information regarding the original image on the basis of the user designation received by the user designation receiving unit 12 so as to display, on the display screen 21, the enlarged image obtained by enlarging the original image displayed on the display 20. For example, in a case where one pixel in the original image is represented by one dot on the display screen 21, the original image is enlarged such that a pixel (hereinafter, referred to as an “enlarged pixel”) of the enlarged image corresponding to the one pixel of the original image is represented by multiple dots on the display screen 21. In this case, a pixel is an example of a part of an image, a region in which the one dot is displayed is an example of a unit region, and a region in which the multiple dots are displayed is an example of an enlarged region. The enlargement processor 13 is provided as an example of an enlarging unit that enlarges an image so as to display, in the enlarged region, the part of the image displayed in the unit region. The enlargement processor 13 will be described in detail later.

The seed setting unit 14 sets a seed on the original image by using the enlarged image on the basis of the user designation received by the user designation receiving unit 12. Specifically, when at least one of the dots representing an enlarged pixel is selected on the enlarged image, the seed setting unit 14 determines, on the basis of the proportion of the selected dot relative to the dots representing the enlarged pixel, a relationship of the feature amount between the enlarged pixel and the already selected enlarged pixel, and the like, whether to select the enlarged pixel. The seed setting unit 14 changes the display from the enlarged image back to the original image and sets the seed on a pixel in the original image corresponding to the enlarged pixel determined to be selected. In the present exemplary embodiment, the seed setting unit 14 is provided as an example of a determining unit that determines that the part of the image is selected. The seed setting unit 14 will also be described in detail later.

The region detecting unit 15 detects a designated region in the original image displayed on the display 20 on the basis of information regarding the seed set in the original image by the seed setting unit 14, the designated region being designated by the user as an image region for the image processing. Actually, the region detecting unit 15 performs processing of segregating the designated region from the other regions in the original image displayed on the display 20. Specifically, the region detecting unit 15 first adds a flag to a pixel of a part for which the seed is set. If the pixel value of the pixel with the seed is close to that of one of neighboring pixels (on the basis of a Euclidean distance between RGB values or the like), the region detecting unit 15 couples the pixels together. If the pixel with the seed is not close to that of the neighboring pixel, the region detecting unit 15 does not couple the pixels together. The region detecting unit 15 repeats the processing to extend the region.

The image processor 16 actually performs the image processing on the designated region thus segregated. For example, the image processor 16 performs adjustment of hue, saturation, and brightness in the segregated designated region or adjustment for enhancing visibility, such as retinex.

The image information output unit 17 outputs the image having undergone the image processing in this manner. The image information having undergone the image processing is thereby transmitted to the display 20. Then, the display 20 displays the image on the basis of the image information.

### Enlargement Processor

How the enlargement processor 13 performs processing will be described using a specific example.

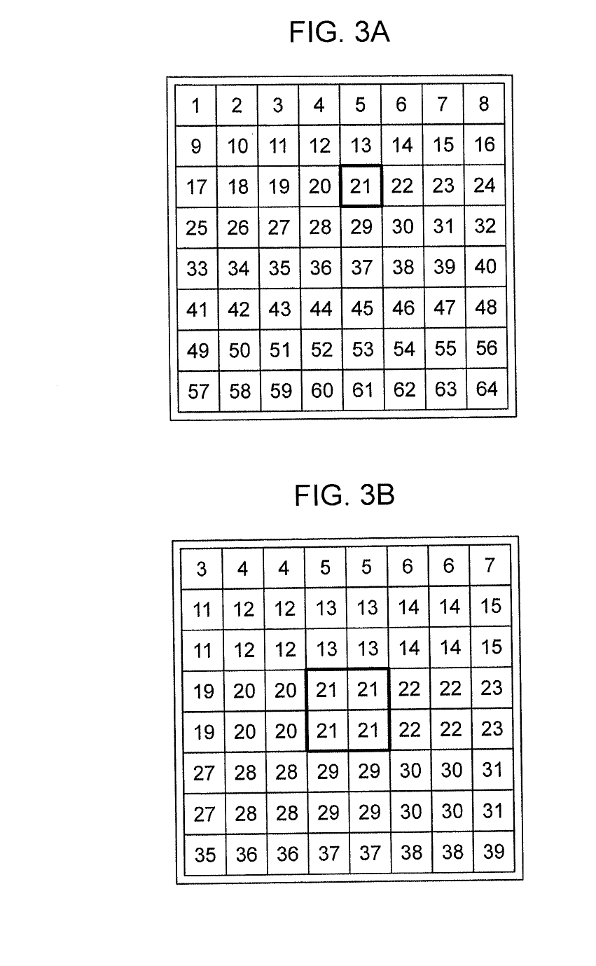

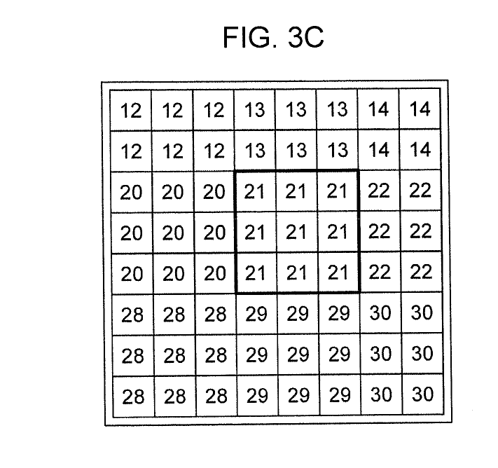

FIG. 3A illustrates an original image, FIG. 3B illustrates an enlarged image obtained by enlarging the original image two times, and FIG. 3C illustrates an enlarged image obtained by enlarging the original image three times. Small squares defined by thin lines in FIGS. 3A to 3C denote dots on the display screen 21. Each dot is numbered, and a dot assigned No. K is hereinafter described as a dot #K. The images in FIGS. 3A to 3C are each represented by 64 dots and thus have the same display resolution.

In the same display resolution situation as described above, the enlargement processor 13 enlarges a region corresponding to one pixel in accordance with an enlargement ratio. In FIGS. 3A to 3C, dots representing the same pixel in the original image and the enlarged images are assigned the same number. In particular, a pixel and enlarged pixels that are represented by dots #21 are each surrounded by a thick line. The pixel and the enlarged pixels each surrounded by the thick line are herein focused. In a case where the enlargement ratio is 2 as in FIG. 3B, the pixel represented by one dot in the original image is represented by 2 dots×2 dots in the enlarged image. In a case where the enlargement ratio is 3 as in FIG. 3C, the pixel represented by the one dot in the original image is represented by 3 dots×3 dots in the enlarged image.

Since a tool of the same size such as a touch pen or a finger of the user is used in selecting a pixel in any image, enlarging the pixel in this manner facilitates selection of the pixel.

Meanwhile, in general image processing software, emphasis is placed on the appearance of an image, and the image is thus enlarged in such a manner that interpolation is performed to result in smooth color changes between pixels. In contrast, in the present exemplary embodiment, emphasis is placed on the way of showing the user enlarged pixels, and thus an image is enlarged in such a manner that pixels in the same color are arranged in a square.

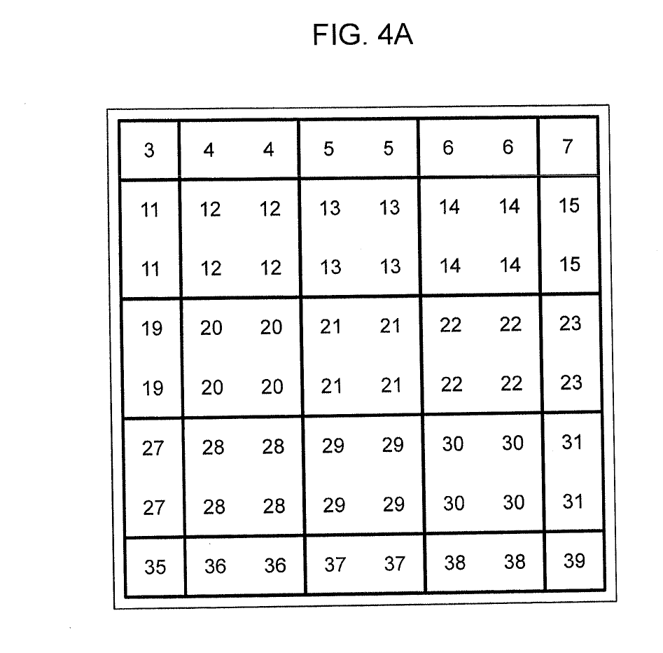

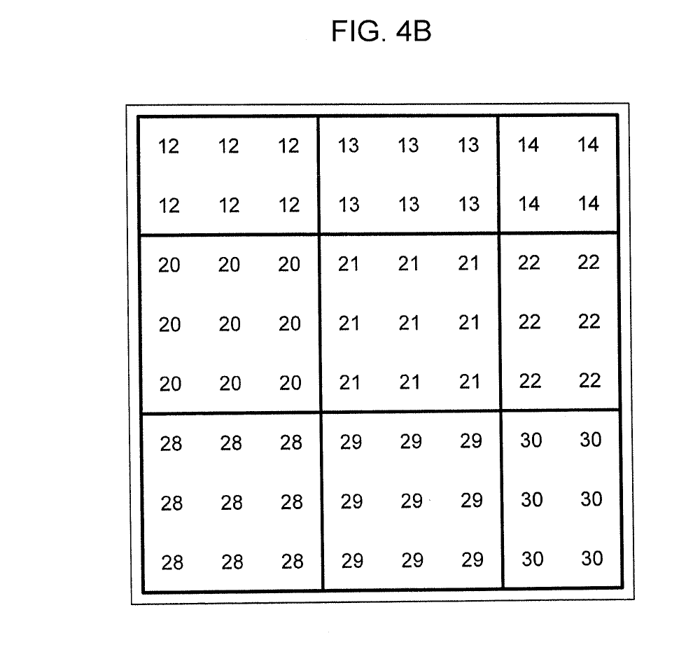

In addition, in the present exemplary embodiment, the enlarged pixels at the time when the enlargement processor 13 enlarges an image may be presented to the user as illustrated in FIGS. 4A and 4B. Specifically, to discriminate on a pixel basis between a specific enlarged pixel represented by multiple dots and the other enlarged pixels, a thick borderline may be displayed between the specific enlarged pixel and the other enlarged pixels. FIG. 4A illustrates a borderline in an enlarged image obtained by enlarging the original image two times, and FIG. 4B illustrates a borderline in an enlarged image obtained by enlarging the original image three times. When the user performs an image enlarging operation, the borderlines make the user feel as if one pixel has been enlarged and help the user to select the pixel. However, each borderline is only an example, and any information may be displayed as long as the information is provided to discriminate the enlarged pixel from neighboring enlarged pixels.

Meanwhile, the following four methods are examples of conceivable methods by which the enlargement processor 13 receives user designation and by which the enlargement processor 13 enlarges an image in accordance with the user designation. In the first method, in response to tapping of the display screen 21 by the user, an image in a predetermined range having the tapped pixel in the center is enlarged at a predetermined ratio. In the second method, in response to designation of a region by the user, the image of the region is fully enlarged on the entire display screen 21. In the third method, in response to a two-finger pinch-out operation by the user, an image is enlarged at the enlargement ratio associated with the operation. In the fourth method, in response to pressing of an enlargement button by the user, an image is enlarged at an enlargement ratio associated with the enlargement button.

Note that particularly in the second and third methods, the enlargement ratio might not be an integral multiple (when percentage is used, an integral multiple of a value of 100%). In this case, for example, the enlargement ratio identified from the operation is rounded to a whole number to obtain an integral multiple, and the enlargement ratio thus rounded may be used when a pixel is enlarged.

### Seed Setting Unit

How the seed setting unit 14 performs processing will be described in detail by using a specific example.

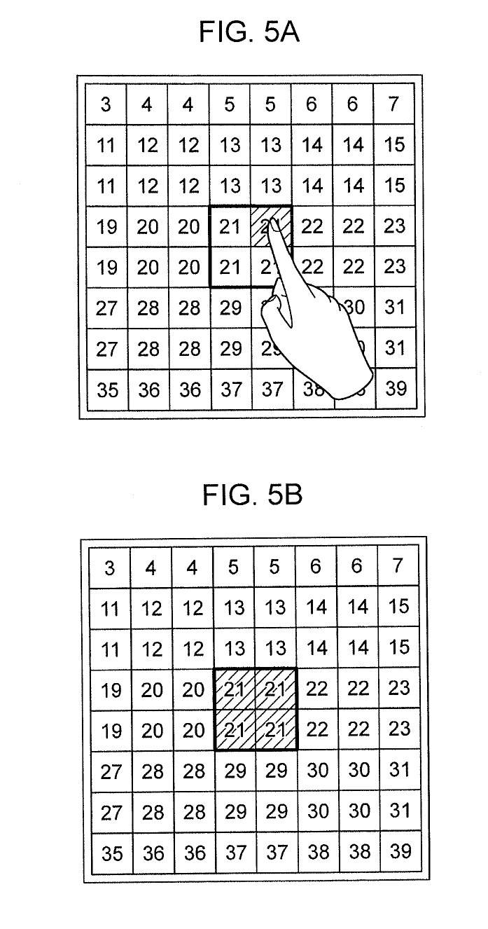

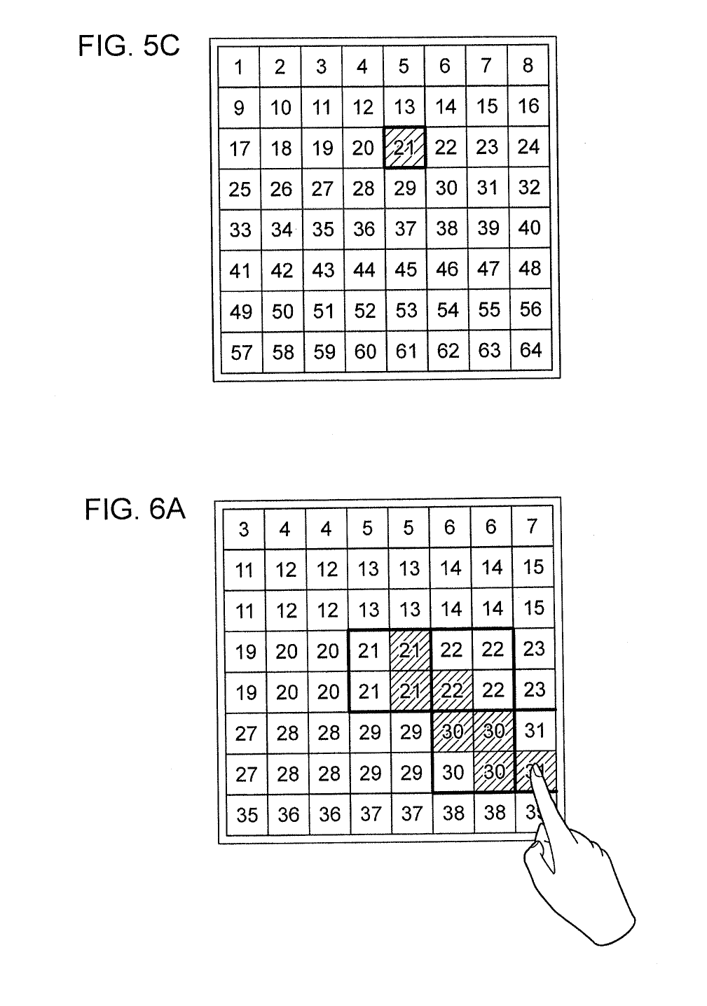

FIG. 5A is a diagram illustrating a state in which a dot is selected on the enlarged image obtained by enlarging the original image two times. Specifically, FIG. 5A illustrates a state in which an upper right one of four dots #21 that represent the enlarged pixel and are surrounded by the thick line is touched and thereby selected, as indicated by the hatched region. FIG. 5B is a diagram illustrating a selection state of the enlarged pixel at this time. FIG. 5B illustrates selection of all of the 2 dots×2 dots representing the enlarged pixel, as indicated by the hatched region. In the present exemplary embodiment, selection of at least one of the 2 dots×2 dots representing the enlarged pixel as described above may be regarded as selection of the entire enlarged pixel represented by the 2 dots×2 dots. Further, FIG. 5C is a diagram illustrating the selection state in the original image at this time. As indicated by the hatched region in FIG. 5C, the selection state of the pixel represented by the dots #21 is maintained even when the original image is displayed again.

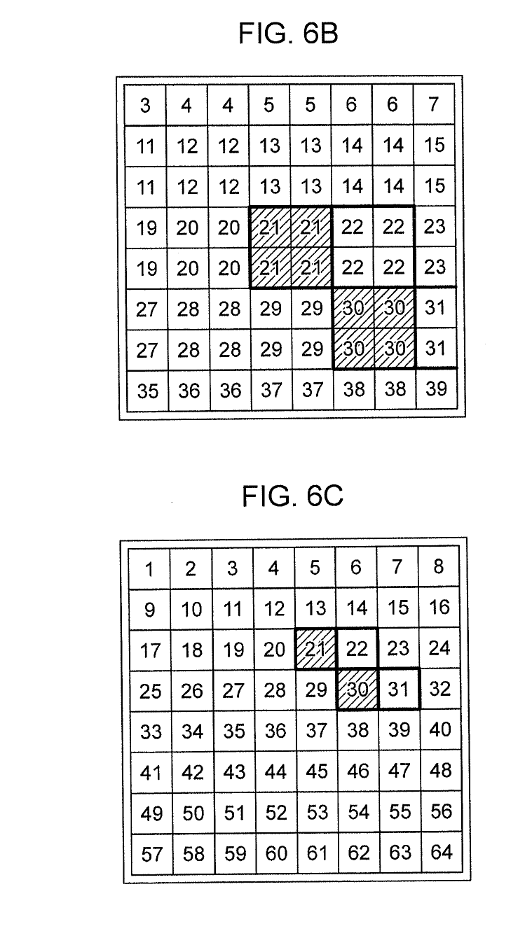

In contrast, in a case where dots are selected on the basis of a line, not a point, the number of selected dots varies depending on the enlarged pixel. FIG. 6A illustrates such a situation. From the 2 dots×2 dots, two dots are selected in an enlarged pixel represented by the dots #21, one dot is selected in an enlarged pixel represented by dots #22, and three dots are selected in an enlarged pixel represented by dots #30. Hence, such variation is taken into consideration. Specifically, on condition that the number of selected dots is larger than a threshold, not on condition that at least one dot is selected as described above, an entire enlarged pixel may be considered to be selected. FIG. 6B is a diagram illustrating a selection state of enlarged pixels in a case where the threshold is 2. Since enlarged pixels represented by only the dots #21 and #30 have a larger number of selected dots than the threshold, the enlarged pixels are selected. FIG. 6C is a diagram illustrating the selection state in the original image at this time. As indicated by the hatched region in FIG. 6C, the selection state of the pixels represented by the dots #21 and #30 is maintained even when the original image is displayed again.

Note that the threshold for the number of dots is herein provided on the assumption that the enlargement ratio is 2, but the threshold is not limited to this. If various enlargement ratios are assumed, a threshold for a proportion of the number of selected dots relative to the number of dots representing an enlarged pixel may be provided.

In FIGS. 5A to 5C, if at least one dot is selected, it is determined that the enlarged pixel is selected. In FIGS. 6A to 6C, if a larger number of dots than the threshold are selected, it is determined that the enlarged pixel is selected. However, these are only examples. A more generalized condition may be used. Specifically, if some of the multiple dots representing an enlarged pixel are selected, it may be determined that the enlarged pixel is selected.

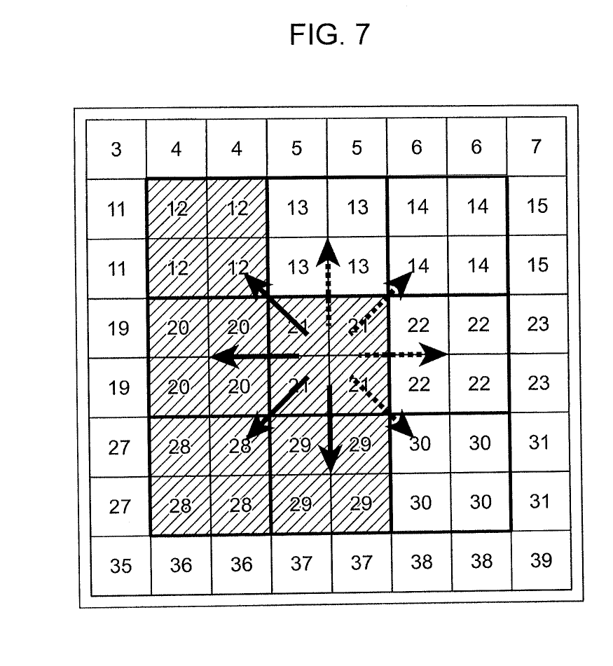

Further in the present exemplary embodiment, whether an enlarged pixel neighboring an already selected enlarged pixel is selected may be determined on the basis of a relationship of the feature amount between the selected enlarged pixel and the neighboring pixel. Any feature amount may be used as long as the feature amount is obtained from pixel values. A feature amount of a color will herein be described as an example. Specifically, when the user selects one enlarged pixel, it is determined that among the enlarged pixels within the predetermined distance from the selected enlarged pixel, one or more enlarged pixels having a color similar to that of the selected enlarged pixel are also selected. FIG. 7 is a diagram illustrating a state of the determination on the selection of enlarged pixels at this time. Specifically, FIG. 7 illustrates a state of the determination on whether one or more enlarged pixels neighboring the selected enlarged pixel represented by the dots #21 are selected. In FIG. 7, the colors of the enlarged pixels represented by dots #12, #20, #28, and #29 are similar to the color of the enlarged pixel represented by the dots #21, and these enlarged pixels are selected as indicated by solid arrows. In contrast, the colors of enlarged pixels represented by dots #13, #14, #22, and #30 are not similar to the color of the enlarged pixel represented by the dots #21, and these enlarged pixels are not selected as indicated by dashed arrows.

Note that examples of the simplest color-similarity determination method include a method by which a Euclidean distance between RGB values is obtained. The method is used to obtain a distance D between a color of (R1, G1, B1) and a color of (R2, G2, B2) in accordance with the following formula.

$$D = \sqrt{\begin{matrix}( R 1 - R 2 ) ( R 1 - R 2 ) + \\ ( G 1 - G 2 ) ( G 1 - G 2 ) + \\ ( B 1 - B 2 ) ( B 1 - B 2 )\end{matrix}} \qquad ( Formula 1 )$$

If the distance D is equal to or less than a threshold, the colors may be determined to be similar to each other.

Note that the condition in which the color of the neighboring enlarged pixel is similar to the color of the enlarged pixel selected by the user is herein used as the condition for selecting the neighboring enlarged pixel, but this is only an example. A more generalized condition for selecting a neighboring enlarged pixel may be used. Specifically, the condition may be a condition in which the feature amount of a neighboring enlarged pixel has a predetermined relationship with the feature amount of an enlarged pixel selected by the user.

The case where dots are selected on the basis of a line, not a point, may also be considered in the method for determining whether to select an enlarged pixel neighboring the selected enlarged pixel in FIG. 7. In this case, to determine whether to select a neighboring enlarged pixel, not only a relationship of the feature amount between the selected enlarged pixel and the neighboring enlarged pixel, but also the proportion of dots selected among dots representing the neighboring enlarged pixel relative to the dots representing the neighboring enlarged pixel (hereinafter, referred to as a dot proportion), is taken into consideration. Specifically, in a case where the enlargement ratio is N, and where the number of selected dots is M, an evaluation value V may be obtained in accordance with the following formula by using the distance D calculated in Formula 1 and a dot proportion (M/N). The distance D, the dot proportion (M/N), and the evaluation value V are examples of a first value, a second value, and a third value, respectively.

$$V = α \cdot \frac{1}{D} + β \cdot \frac{M}{N} \qquad ( Formula 2 )$$

Note that α and β are weights assigned to the distance D and the dot proportion (M/N), respectively and are each a positive number. The evaluation value V is increased as the distance D is decreased and as the dot proportion (M/N) is increased. Accordingly, if the evaluation value V is equal to or larger than a threshold, it may be determined that the neighboring enlarged pixel is selected. However, this is only an example. A more generalized condition may be used in consideration of the use of a formula other than Formula 2. Specifically, if the evaluation value V satisfies a predetermined condition, it may be determined that the neighboring enlarged pixel is selected.

Although a relationship between values of α and β has not been described, for example, the value of β may be set larger than the value of α because the higher the enlargement ratio is, the higher the reliability of the dot proportion (M/N) becomes. In other words, a modification is also conceivable in which the higher the enlargement ratio is, the larger the value of β compared with the value of α is set.

### Operation of Image Processing Apparatus

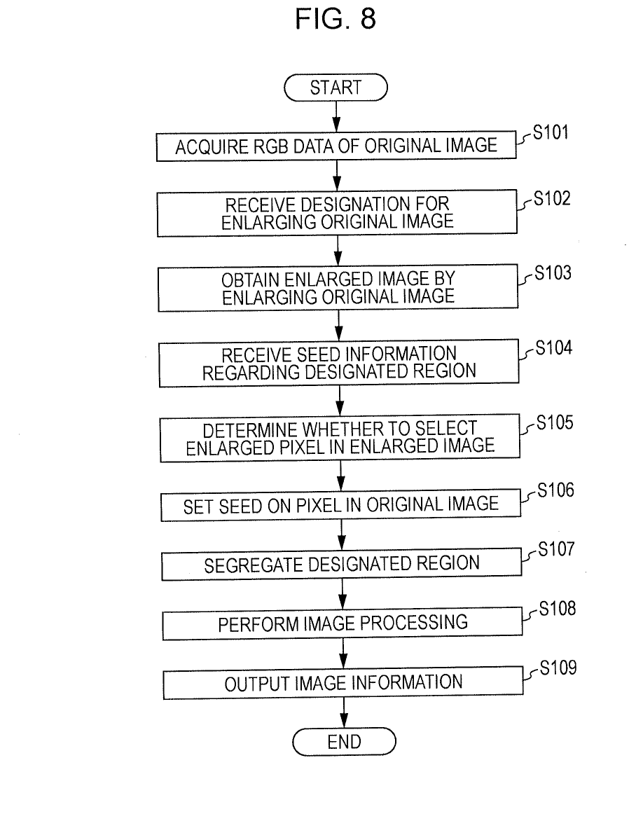

FIG. 8 is a flowchart illustrating an example of operation of the image processing apparatus 10 in the exemplary embodiment of the present invention.

The image information acquiring unit 11 first acquires RGB data as image information regarding an original image for image processing (step 101). The RGB data is transmitted to the display 20, and the original image yet to undergo the image processing is displayed on the display 20.

When the user designates enlargement of the original image displayed on the display 20 by using the input device 30, the user designation receiving unit 12 receives the designation of the enlargement (step 102).

The enlargement processor 13 performs, on the RGB data acquired in step 101, image processing for enlarging a pixel at a designated enlargement ratio, for example, as illustrated in FIGS. 3A to 4B (step 103). The RGB data having undergone the image processing is transmitted to the display 20, and the displayed original image is replaced with an enlarged image obtained by enlarging the original image.

Next, the user inputs a seed such as a movement line by using the input device 30, thus designating a designated region that is an image region for the image processing. The user designation receiving unit 12 receives information regarding the seed (step 104).

The seed information is information for selecting a dot corresponding to an enlarged pixel in the enlarged image displayed on the display 20. Accordingly, the seed setting unit 14 performs the processing described with reference to FIGS. 5A to 7 and thereby determines whether to select the enlarged pixel on the basis of information for selecting a dot (step 105). The seed setting unit 14 changes the display from the enlarged image back to the original image and sets the seed on a pixel in the original image corresponding to the enlarged pixel (step 106).

The region detecting unit 15 performs processing of segregating a designated region on the basis of the seed set in step 106 (step 107).

The image processor 16 performs the image processing on the segregated designated region (step 108).

The image information output unit 17 outputs image information having undergone the image processing (step 109). The image information is RGB data. The RGB data is transmitted to the display 20, and the display screen 21 displays the image having undergone the image processing.

### Hardware Configuration of Image Processing Apparatus

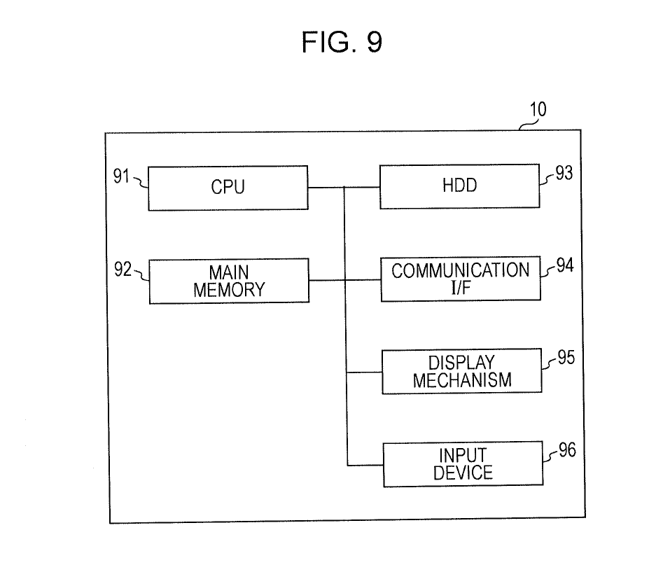

FIG. 9 is a diagram illustrating a hardware configuration example of the image processing apparatus 10. As illustrated in FIG. 9, the image processing apparatus 10 includes a central processing unit (CPU) 91 that is a computing unit, a main memory 92 that is a memory, and a magnetic disk device (hard disk drive (HDD)) 93. The CPU 91 runs the OS and various software applications to implement the processors described above. The main memory 92 is used to store software, data used for running the software, and the like. The magnetic disk device 93 is used to store data and the like input to and output from the software. One or both of the main memory 92 and the magnetic disk device 93 are used to implement a memory. The image processing apparatus 10 further includes a communication interface (I/F) 94 for communicating with an external device, a display mechanism 95 that is an example of a display including a video memory or a display, and an input device 96 such as a keyboard or a mouse.

### Program

The aforementioned processing performed by the image processing apparatus 10 in the present exemplary embodiment is prepared as a program such as a software application.

Accordingly, the processing performed by the image processing apparatus 10 in the present exemplary embodiment may also be regarded as a program causing a computer to execute a process including: displaying an image on a display screen including multiple unit regions in which a designation operation by an operator is detected; enlarging the image such that a part of the image displayed on one of the multiple unit regions of the display screen is displayed on an enlarged region including two or more of the multiple unit regions neighboring each other of the display screen; and determining that the part of the image is selected if the designation operation by the operator is detected in all or at least one of the unit regions included in the enlarged region.

The program that implements the present exemplary embodiment may be provided through not only a communication unit but also a recording medium such as a compact disc read only memory (CD-ROM) storing the program therein.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A selection support apparatus comprising:
a display that displays an image on a display screen including a plurality of unit regions in which a designation operation by an operator is detected;
an enlarging unit that enlarges the image such that a part of the image displayed on one of the plurality of unit regions of the display screen is displayed on an enlarged region including two or more of the plurality of unit regions neighboring each other of the display screen; and
a determining unit that determines that the part of the image is selected if the designation operation by the operator is detected in all or at least one of the unit regions included in the enlarged region.

2. The selection support apparatus according to claim 1,
wherein if the designation operation by the operator is detected in the at least one of the unit regions included in the enlarged region, and if a proportion of the unit region in which the designation operation by the operator is detected relative to the unit regions is higher than a predetermined threshold, the determining unit determines that the part of the image is selected.

3. The selection support apparatus according to claim 1,
wherein if a feature amount of the part of the image and a feature amount of a different part of the image satisfy a predetermined relationship after the determining unit determines that the part of the image is selected, the determining unit determines that the different part of the image is also selected, the different part being displayed in a different enlarged region within a predetermined distance from the enlarged region.

4. The selection support apparatus according to claim 1,
wherein a first value indicates a relationship between a feature amount of the part of the image and a feature amount of a different part of the image displayed in a different enlarged region within a predetermined distance from the enlarged region, a second value indicates a proportion of one of unit regions, in which the designation operation by the operator is detected, included in the different enlarged region, relative to the unit regions included in the different enlarged region, and if a third value calculated on the basis of the first value and the second value satisfies a predetermined condition after the determining unit determines that the part of the image is selected, the determining unit determines that the different part of the image is also selected.

5. The selection support apparatus according to claim 4,
wherein the determining unit calculates the third value such that the second value is weighted more than the first value, the second value being weighted more as an enlargement ratio used for enlarging the image by the enlarging unit becomes high.

6. The selection support apparatus according to claim 1,
wherein when the enlarging unit enlarges the image, the display further displays information for discriminating between the enlarged region and a different enlarged region that neighbors the enlarged region.

7. A selection support method comprising:
displaying an image on a display screen including a plurality of unit regions in which a designation operation by an operator is detected;
enlarging the image such that a part of the image displayed on one of the plurality of unit regions of the display screen is displayed on an enlarged region including two or more of the plurality of unit regions neighboring each other of the display screen; and
determining that the part of the image is selected if the designation operation by the operator is detected in all or at least one of the unit regions included in the enlarged region.

8. A non-transitory computer readable medium storing a program for causing a computer to execute a process comprising:
displaying an image on a display screen including a plurality of unit regions in which a designation operation by an operator is detected;
enlarging the image such that a part of the image displayed on one of the plurality of unit regions of the display screen is displayed on an enlarged region including two or more of the plurality of unit regions neighboring each other of the display screen; and
determining that the part of the image is selected if the designation operation by the operator is detected in all or at least one of the unit regions included in the enlarged region.
